(19) United States
(12) Patent Application Publication
(10) Pub. No.: US 2013/0138470 A1
(43) Pub. Date: May 30, 2013

(54) SYSTEM AND METHOD FOR SUPPLY CHAIN OPTIMIZATION

(71) Applicants: Abhishek Goyal, Dehradun (IN); Rajeev Ranjan, Bangalore (IN); Nikhil Kumar, Delhi (IN); Padmini Ramakrishna Talagavaram, Bangalore (IN)

(72) Inventors: Abhishek Goyal, Dehradun (IN); Rajeev Ranjan, Bangalore (IN); Nikhil Kumar, Delhi (IN); Padmini Ramakrishna Talagavaram, Bangalore (IN)

(73) Assignee: INFOSYS LIMITED, Bangalore (IN)

(21) Appl. No.: 13/450,524

(22) Filed: Apr. 19, 2012

(30) Foreign Application Priority Data
Nov. 25, 2011 (IN) 4072/CHE/2011

(51) Int. Cl. G06Q 10/06

(52) U.S. Cl. 705/7.26

(57) ABSTRACT

Method and systems for supply chain optimization include identifying at least one existing system limitation associated with a high technology organization, identifying a supply chain optimization scheme enabled by an enterprise resource planning implementation for the high technology organization on the basis of the one or more system limitations, comparing one or more process flows and requirements associated with the supply chain of the high technology organization with a plurality of pre-developed process flows and requirements, deploying a pre-developed enterprise resource planning system configuration kit for the enterprise resource planning implementation; and providing a key performance indicator framework based on best practices and benchmarks relevant to the high technology organization, wherein the key performance indicator framework comprises one or more performance metrics by which the time and cost efficiency of a supply chain is measured.

RELATED APPLICATION DATA

This application claims priority to Indian Patent Application No. 4072/CHE/2011, filed Nov. 25, 2011, which is hereby incorporated by reference in its entirety.

### FIELD

The disclosed embodiment relates generally to the optimization of a supply chain management process. In particular, the disclosed embodiment relates to end to end supply chain optimization in a high technology industry through the integration of various aspects of the supply chain management process.

### BACKGROUND

In traditional high technology enterprises, such as semiconductor, electronics design and manufacturing oriented enterprises, supply chains may be managed in a piecemeal manner i.e. multiple departments within the enterprise may each execute a particular aspect of the company's supply chain process, and generally track their own performance. Moreover, the information technology (IT) systems of these enterprises may have also evolved in a modular, department oriented silos, which, in turn, may result in a complex, heterogeneous landscape across the entire supply chain process. Such modularity may additionally cause piecemeal, or fragmented, implementations of enterprise resource planning systems, targeted toward specific functions in the enterprise.

This function centric, complex supply chain ecosystem may result in a variety of problems for enterprises in the high technology sector, which are, broadly, classed into business and technology related problems. For example, the absence of holistic strategies to manage supply chain volatility and demand/supply uncertainty is a business issue that is a major cause of inefficiency. Another potential business issue is lack of flexibility in the associated supply chain. Such inflexibility may cause the supply chain to be unable to handle the complexity of global and local partner networks. Additionally, an inflexible supply chain, coupled with piece meal management strategies, is generally indicative of an inability to effectively manage risk, which causes time, cost and integration inefficiencies. These business issues together may result in the lack of a cost optimized, regional, and integrated supply chain that affects the competitiveness of the high technology enterprise.

Additional complexity may be found in the technological implementation, where too many siloes in systems may exist due to inorganic growth that may result from, for example, mergers and acquisitions. Proximate causes of such growth may include a lack of process and application integration, decentralized ownership of the various processes in the supply chain and generally inconsistent business processes. Too many nominally independent implementations along the end-to-end supply chain may additionally result in too many partners and dependencies across the supply chain. In turn, too many partners may cause an inability in, or difficulty with, supply integration in real-time, a lack of collaboration standards, and an inability to support new business models rapidly.

Additionally, such a complex eco-system has serious, and detrimental, effects on response time by generating an excess number of incompatible demand and supply variables, and on any attempts at collaboration across the supply chain processes. The problem of lag in response time can translate to an inability to respond to sudden demand and supply disruption scenarios and excessive data latency that may together reduce the possibility of a proactive business response to any such disruption scenarios.

In sum, the multiple systems involved in a non-process centric and modular supply chain management process slows down and detrimentally affects decision making, as well as implementation response times by posing both businesses related as well as technology hurdles.

Ideally, strategies for supply chain optimization provide wider reach than mere function based solutions, and extend to solutions that integrate specific requirements to complete a business flow. Such an end-to-end strategy may require different lines of business to work closely to maximize efficiencies and drive bottom-line results that are crucial to the execution of day to day business and yet allow the flexibility to adapt to changing requirements.

There is a need, then, for an end to end supply chain optimization implementation that allows high technology enterprises to shift along four, key dimensions. Firstly, from a heterogeneous and complex information technology (IT) landscape to an integrated, and open, framework of IT systems. Second, from a partner network founded on relationships and human to human interaction to a partner network founded on rapid collaboration. Thirdly, from a reactive approach to data latency, to a supply chain that possesses an ability to sense and respond to changes in processes therein. Fourth, and finally, from variability in decision making, to an integrated model that incorporates process detail, system detail as well as metrics that measure and quantify responses.

### SUMMARY

The disclosed embodiment relates to a computer aided method for accelerating end-to-end supply chain optimization in a high technology organization.

In accordance with a described embodiment, the method comprises identification of at least one existing system limitation associated with the high technology organization. It further comprises identification of a supply chain optimization scheme enabled by an enterprise resource planning implementation for the high technology organization on the basis of the one or more system limitations identified. It further comprises comparison of one or more process flows and requirements associated with the supply chain of the high technology organization with a plurality of pre-developed process flows and requirements, wherein the pre-developed process flows and requirements are identified on the basis of best practices associated with the supply chain optimization scheme and contextualized to a high technology sector in which the high technology organization operates. It further comprises deployment of a pre-developed enterprise resource planning system configuration kit for the enterprise resource planning implementation, wherein the configuration kit serves to configure the supply chain optimization scheme in accordance with the plurality of pre-developed process flows. In accordance with the embodiment described, the method finally relates the provision of a key performance indicator framework based on best practices and benchmarks, wherein the key performance indicator framework comprises one or more performance metrics by which the time and cost efficiency of a supply chain is measured, and one or more business issues faced by the high technology organization is derived thereby.

In accordance with an additional embodiment, a system for accelerating end to end supply chain optimization in a high technology organization is described, the system comprising a processor readable storage medium in communication with a processor, the processor readable storage medium containing one or more programming instructions configured to identify a supply chain optimization scheme enabled by an enterprise resource planning (ERP) implementation for a high technology organization, wherein the supply chain optimization scheme is identified on the basis of the one or more system limitation in the supply chain of the high technology organization. The system additionally comprises a comparison module implemented by said programming instructions, wherein the comparison module is adapted to compare one or more process flows and requirements associated with the supply chain of the high technology organization with a plurality of pre-developed process flows and requirements, wherein the pre-developed process flows and requirements are identified on the basis of best practices associated with the supply chain optimization scheme and contextualized to a high technology sector in which the high technology organization operates. The system similarly additionally comprises a deployment module adapted to deploy a pre-developed configuration kit for an ERP implementation, wherein the pre-developed configuration kit serves to configure the supply chain optimization scheme in accordance with the plurality of pre-developed process flows, and, finally, provides a key performance indicator (KPI) framework based on best practices and benchmarks relevant to the high technology organization, wherein the key performance indicator framework comprises one or more performance metrics by which the time and cost efficiency of the supply chain is measured.

### DRAWINGS

These and other features, aspects, and advantages of the disclosed embodiment will be better understood when the following detailed description is read with reference to the accompanying drawings in which like characters represent like parts throughout the drawings, wherein:

FIG. 1 is a flow diagram illustrating a method of accelerating an end-to-end optimization of a supply chain, in accordance with an embodiment.

FIG. 2 is an illustrative architecture diagram of a computing environment in which an enterprise resource planning application for optimizing a supply chain process may be deployed.

FIG. 3 is an illustration of a ‘to-be’ process flow for an installation, services and project management process stage, in accordance with a disclosed embodiment.

FIG. 4 is an end-to-end illustration of process stages involved in a supply chain managed by a high technology organization, in accordance with a disclosed embodiment.

FIG. 5 is a depiction of activities involved in the optimization of a planning and demand management process stage, in accordance with a disclosed embodiment.

FIG. 6 is a depiction of activities involved in the optimization of a sourcing and operations planning process stage, in accordance with a disclosed embodiment.

FIG. 7 is a schematic illustration of processes across a plurality of process segments in the supply chain of a high technology organization, in accordance with at least one disclosed embodiment.

### DETAILED DESCRIPTION

The following description includes a full and informative description of the best method and system presently contemplated for carrying out the disclosed embodiment which is known to the inventors at the time of filing the patent application.

The disclosed embodiment describes a system and method for supply chain optimization in an organization in a high technology sector, such as, semiconductor design and manufacturing. Embodiments of the invention described may facilitate a range of processes across the supply chain of the high technology organization. The problem of heterogeneous and complex information technology (IT) implementation across a supply chain may be solved by the adoption of an integrated, and open, framework of IT systems, which is facilitated by the implementation of the disclosed embodiments.

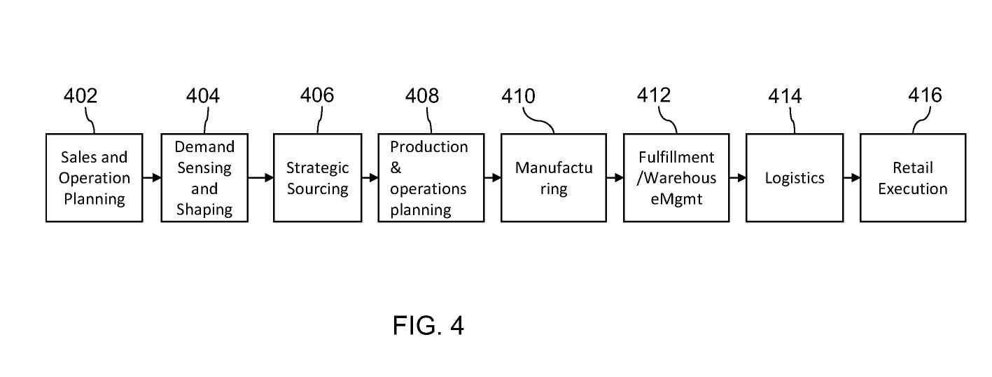

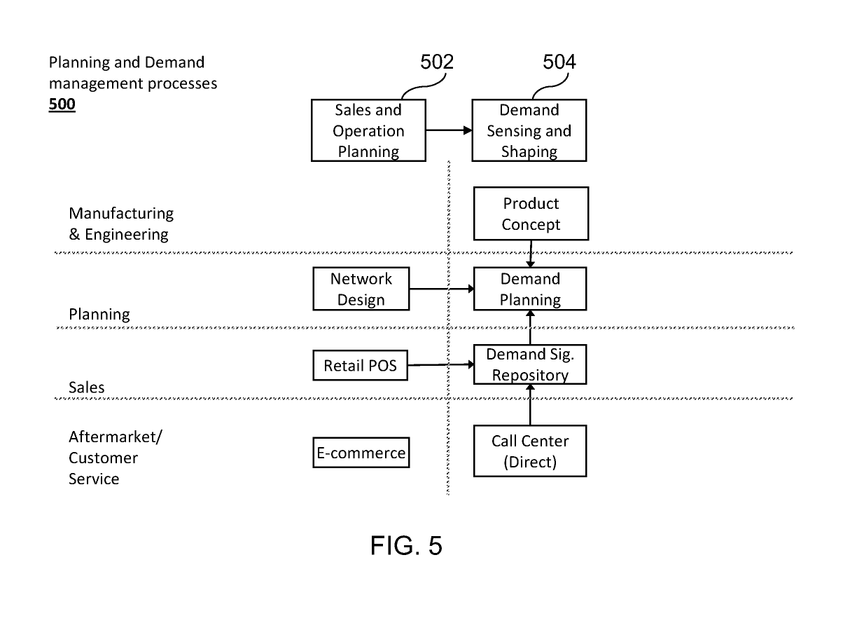

The range of supply chain management processes across which embodiments of the present invention are applicable may be further segmented into a set of discrete process stages, or chevrons. To that end, an example set of process stages are depicted in FIG. 4. Further, as illustrated, process stages may be interlinked, or connected. That is, an efficient outcome of activities across a process stage 402 may be dependent on the efficient planning of one or more activities in the process stage 404. One or more sales and operations planning processes, then, may be operatively connected to one or more processes in a demand sensing and shaping process stage. An example of such is further illustrated with reference to FIG. 5.

FIG. 5 is an illustration of planning and demand management processes 500 involved in the execution of a Sales and Operations Planning (S&OP) process stage, 502, and a Demand Sensing and Shaping process stage, 504. FIG. 5 additionally depicts one or more dependencies of operations within 504 on operations within 502.

The importance of S&OP lies in enabling companies to understand and manage their risk by leveraging forward-looking planning that links executive decision to shop floor execution. A typical S&OP process may include one or more review processes related to demand, supply, finance, and executive organization. Demand sensing and Shaping processes, in contrast, may generally be directed toward the generation and optimization of demand forecasts, among other activities. S&OP process activities across channels in the supply chain, such as a review of strategies in e-commerce, may impact demand forecasts in the sales and customer service sectors of the supply chain, as depicted.

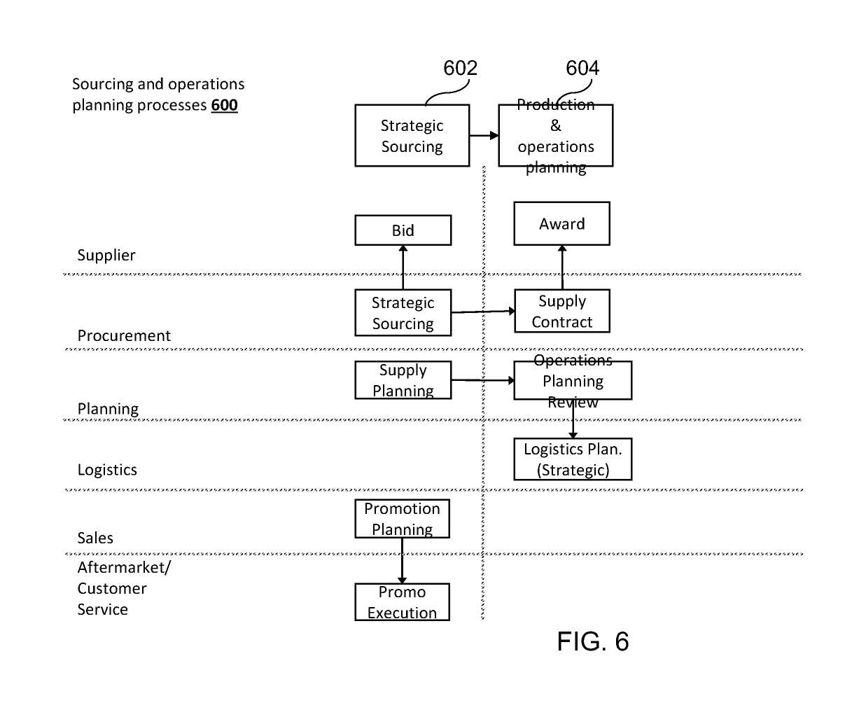

In an additional example, FIG. 6 is an illustration of processes involved in the execution of a Strategic Sourcing process stage, 602, and a Productions and Operations Planning process stage, 604. FIG. 6 additionally depicts a plurality of sub-processes within each of the above process stages, and dependencies between them. For example, the success of a supply contract may be contingent upon realizing efficiencies in procurement by means of strategic sourcing.

More specifically, Strategic sourcing is a procurement process that works toward revaluation of the long term purchasing activities of a company. For a manufacturing organization, for instance, this is an important step in supply chain management. It is especially critical in a high technology manufacturing industry, such as semiconductor manufacturing, as the profit margins of organizations in such a sector are dependent on receiving profitable procurement deals for large volume purchases.

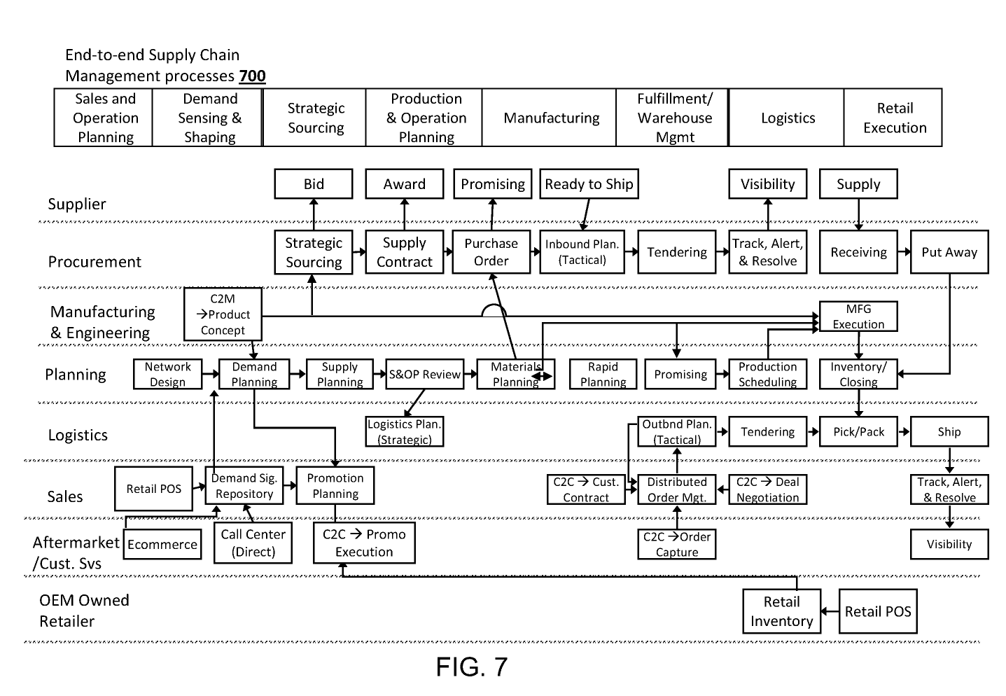

An end-to-end set of supply chain management processes that incorporates the previously described process stages, 700, is shown in FIG. 7. FIG. 7 depicts the interrelationship between process stages and operations or function areas therein across a supply chain, from an initial demand stage to a final delivery stage. Efficiencies in supply chain management, then, may be increased by exploiting feedback, or areas of interaction, between process stages. A significant impediment thereto may lie in the heterogeneity of IT systems deployed across the enterprise. Piecemeal, or fragmented, implementations of enterprise resource planning systems, targeted toward specific functions in the enterprise are a source of inefficiency that may be targeted for optimization, for example.

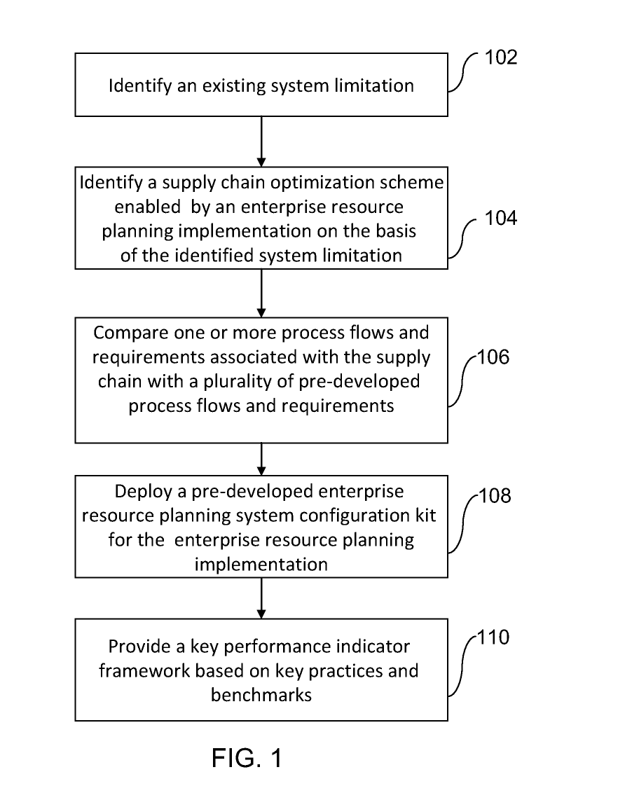

To that end, embodiments for a method of accelerating an end-to-end optimization of a supply chain are described with reference to, firstly, FIG. 1.

At step 102 of FIG. 1, an existing system limitation in the high technology organization is identified. A system limitation, or pain point, may be generally defined as an existing challenge, or as an area of relative inefficiency, in a process deployed by the client organization. For example, one or more system limitations in a sales and operations planning process may include an inability to link strategic and operational plans for supply processes, an inadequate or nonexistent structure to support real time collaboration for decision making, an inability to easily model and compare options, project impact and apply predictive analytics for key business metrics, and an inability to shape demand to meet financial objectives. In an additional example, one or more system limitations in a logistics process managed by the client organization may include, firstly, a lack of an integrated logistics solution, secondly, high freight spend and inaccuracies in freight settlement, thirdly, high inventory levels, and lack of real time information/supply chain visibility, fourth, regulatory and environmental compliance requirements, and finally, a need for a decision support system.

In order to effectively identify a system limitation, a business model describing at least the high level value chain of the organization may be studied. An investigation of system limitations may further include internal and external sources of information. External sources of information may include, for example, a survey of the industry context in which the organization operates. Such a survey may cover trends and challenges in a targeted business sector, and may be additional oriented toward the activity of one or more competitors in the targeted business sector relative to the activity of the client organization.

Internal sources of information may include an analysis of the business and Information Technology (IT) strategy of the client organization and feedback from one or more business process owners within the organization about challenges encountered. In this way, the scope of the one or more system limitations that are relevant to one or more supply chain processes across the client organization may be additionally identified. The analysis of a supply chain process in an organization may include information about suppliers and customers.

In some embodiments, at step 102, the collection and analysis of internal and external sources may be performed by means of an interactive, purpose directed workshop.

At step 104, a supply chain optimization scheme enabled by an enterprise resource planning (ERP) implementation on the basis of the identified system limitation is identified. In some embodiments, the ERP scheme deployed in the supply chain optimization strategy directed toward a high technology organization may complement a previously deployed ERP solution by the high technology organization. In order to accomplish this, an end-to-end supply chain process may be logically segmented into a plurality of chevrons, or discrete process stages, and a discrete set of ERP implementations deployed across all processes that are logically grouped in a chevron.

To this end, the chevrons defined may cover, independently, sales and operations planning processes, demand sensing and shaping processes, strategic sourcing processes, production and operations planning processes, manufacturing processes, fulfillment or warehouse management processes, logistics processes, and, finally, retail execution, installation, services and product management processes.

In accordance with a preferred embodiment, the ERP implementation identified to optimize sales and operations planning may include Oracle® Demantra™ Demand Management and Oracle® Demantra™ Sales and Operations Planning In another aspect, the ERP implementation identified to optimize demand sensing and shaping processes may include Oracle® Demantra™ Demand Management and Oracle® Demantra™ Predictive Trade Planning In another aspect, the ERP implementation identified to optimize strategic sourcing processes may include Oracle® Procurement, Oracle® Strategic Sourcing, and Oracle® iSupplier™ Portal. In another aspect, the ERP implementation identified to optimize productions and operation planning may include Oracle® Advanced Supply Chain Planning, Oracle® Rapid Planning, Oracle® Production Scheduling, Oracle® Advanced Planning and Command Center and Oracle® Inventory Optimization. In another aspect, the ERP implementation identified to optimize manufacturing processes may include Oracle® Manufacturing Execution System, Production Scheduling, Mobile Supply Chain, and Agile (PLM) Product Collaboration. In another aspect, the ERP implementation identified to optimize fulfillment and warehouse management processes may include Oracle® Warehouse Management, Oracle® Transportation Management, Oracle® Order Management, Oracle® Shipping, and Oracle® Inventory. In another aspect, the ERP implementation identified to optimize retail execution, installation, services and project management processes may include Retek®, and Oracle® Primavera™.

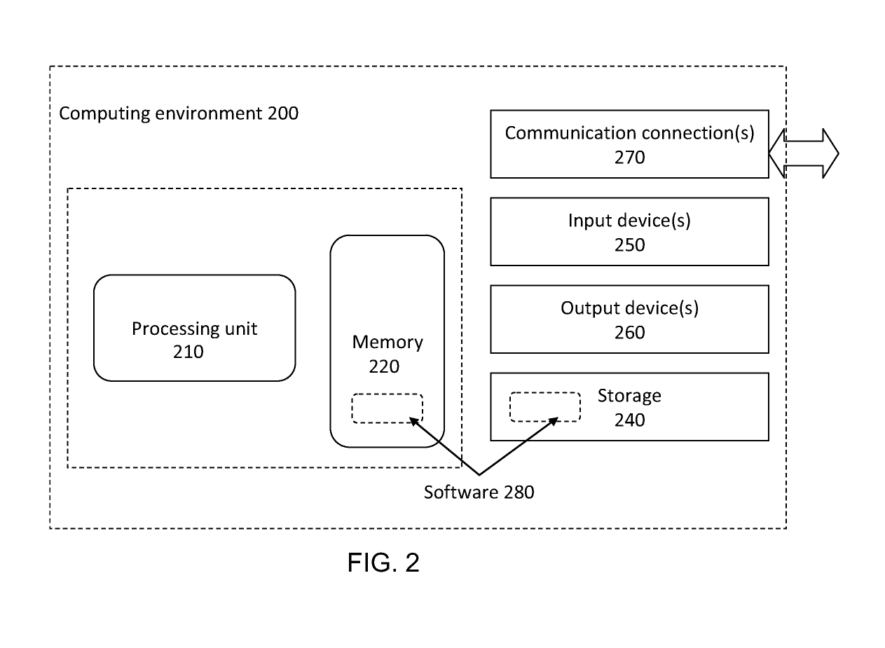

The implementation environment for the operationalization of an enterprise resource planning deployment specific to a process stage is further detailed with reference to FIG. 2, wherein a computing environment 200 where an ERP implementation may be operationalized is depicted. The computing environment may comprise a processing unit 210, a communication connection 270, an input device 250, an output device 260, and a processor readable storage medium 240, in operable communication with the processing unit 210. The computing environment may additionally run an enterprise resource planning software 280, the software 280 stored on the storage medium 240.

At step 106, one or more process flows and requirements associated with the supply chain are compared with a plurality of pre-developed process flows and requirements.

The pre-developed process flows and requirements may be defined in a business requirements document, which, itself, is developed on the basis of an aggregation of best practices in the industry at large that are relevant to said process stage, and on the basis of input from one or more subject matter experts.

The business requirement document defined may be specific to a particular chevron, or discrete process stage, within the end-to-end supply chain. For example, in a disclosed embodiment, a pre-developed business requirement document defined may map a set of processes related to installation services and project management.

More specifically, as in the described embodiment, installation services and project management are key functions within the end-to-end, or demand to delivery, supply chain process, and primarily deal with project execution. This process stage may cover the planning of projects, project execution, project closure, as well as critical touch points within the supply chain for the successful execution of a project. In the embodiment described, Oracle® Primavera P6 may be the main tool considered for project planning, and the Oracle® Rapid Planning tool may be used to manage supply planning

The business requirements document defined, then, may include transaction flows of one or more processes in the chevron, and scenario analysis. For example, a requirements document mapping installation services and project management may be structured as follows:

Firstly, one or more transaction flows may be defined. Transaction flows may map activities across a particular chevron. An example transaction flow defined is a ‘to-be’ transaction flow, which maps a present activity state to a desired activity state. For example, a ‘to-be’ transaction flow for an installation, services and project management chevron may depict how extant, or previously encountered, projects are maintained, and detail the consequences of integrating the project management process with the overall demand-to-delivery process.

Then, scenarios detailing activity across a process may be defined. To continue the example above, a project initiation to project base plan creation, a process for supply initiated change, and a process for a business initiated change, may be detailed in a business requirements document for an installation, services and project management chevron.

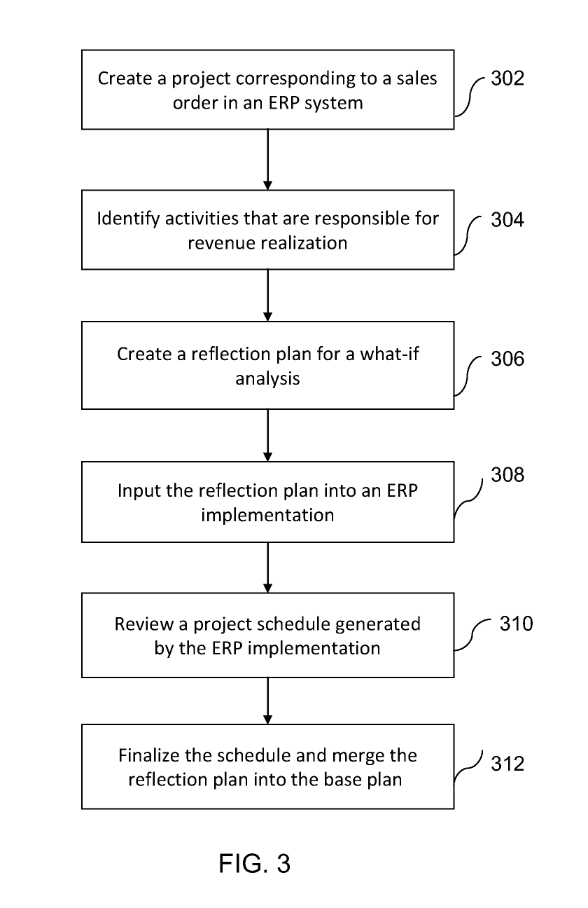

Specifically, an example scenario detailing project initiation to project base plan creation is further detailed with reference to FIG. 3. As depicted in 302, the scenario may be devolved into a series of steps, including, firstly, the creation of an internal sales order—a sales order may be created for a particular client specification. Input for this sales order may be received directly from a customer, in order to better understand project requirements.

Second, the creation of a sales order line—As depicted in 304, sales order lines may be created for a sales order. Sales order lines may have tentative customer requirement dates for equipment/product mentioned on the sales order line.

Third, the input of project milestones—As depicted in 306, high level product/equipment delivery milestones may be derived from the creation of sales order lines.

Fourth, as depicted in 308, the generation of a report from an order management system—on creating a sales order, a report may be generated from an associated order management system. The report may additionally serve as an input for a project plan to be prepared by a project manager.

Fifth, the creation of a base project plan—As depicted in 310, a project corresponding to the sales order may be created. Milestone details may be updated in the project. Links may be established between the order and the project by assigning codes. Material and resource information may be recorded in the project plan.

Sixth, the creation of a reflection plan—As depicted in 312, a reflection plan may be created to perform a what-if analysis and make changes in accordance with inputs from a planning system or a customer. In some instances, a reflection plan may be a copy of an original base plan used by the project manager in order to better synchronise delivery schedules with a supply planner.

Modifications to, or deviations from, the pre-defined ‘to-be’ transaction flows and processes may be arrived at on the basis of a requirements analysis of the client organization. Generally, modifications, where necessary, may be compared or evaluated against the pre-defined processes to ascertain whether they would provide additional competitive advantage, or increase operational efficiency, or support customer strategies, or have a positive impact on financial metrics associated with the project or process involved, or improve employee satisfaction, or improve partner satisfaction, where a partner is a customer or a vendor, or enable another business process or segment in the value chain. Where there are gaps in a requirements set associated with the client organization, a requirements set derived from the predefined business requirements documents may be used to provide additional detail. Once draft processes are formulated, the ‘to be’ process transaction flows may be validated in a conference room pilot or a process workshop. If gaps are identified in a process, then sub-processes derived from the pre-defined business requirements document may be used to further detail out the process. An iterative isolation of sub-processes, where necessary, may be performed in the conference room pilots, or process workshops.

In the example embodiment described, an ERP fit-gap analysis may be additionally performed in order to refine requirements associated with a process stage. An ERP fit gap analysis is a methodology where processes associated with an enterprise are compared with the functionality of an ERP system. In the process of such comparison, a listing of matches, and gaps, between pre-existing enterprise processes and the system functions of the ERP implementation may be prepared. The local processes associated with the enterprise may be adapted to be conformant with those extant in the ERP implementation, or, alternatively, extant across the industry sector by means of a fit gap analysis.

At step 108, a pre-developed enterprise resource planning system configuration kit for the enterprise resource planning implementation is deployed. In a further step, 110, a key performance indicator framework based on key practices and benchmarks is provided.

Following the finalization of business requirements for a process stage, configuration parameters for the ERP scheme associated with the process stage may be derived. Configuration parameters serve as a set of input parameters for a selected ERP application, and are specific to the particular ERP scheme chosen. In some embodiments, configuration parameters used may be piloted in the process workshops or conference room pilots held during a requirements finalization step. In some embodiments, configuration parameters may be specific to the particular Oracle® ERP implementation deployed for a particular process stage. Configuration parameters may additionally be provided as data in a spreadsheet, and updated manually into an ERP application.

Further, the composition of a configuration parameter sheet may be dependent on the finalized business requirements, the behavior of the selected ERP application, and adjusted in accordance with modifications to either. Where configuration parameters selected are required to be updated in accordance with a modification to business requirements, updates may be performed in an ERP instances configured in a testing configuration and deployed following validation of one or more functional requirements associated with the test ERP instance. More specifically, configured ERP instances may be iteratively tested and results compared against one or more selected business requirements. Based on test results, iterations may be scheduled on configuration parameter sets provided in a parameter sheet and the ERP test instances, before the parameters tested are finalized and moved to an ERP production instance.

In a preferred embodiment, the ERP scheme selected for implementation in a particular process stage may be tailored by means of one or more enhancements. Enhancements may include an inventory turns dashboard, which shows inventory cycles or turns over a selected time period, an On Time Delivery Dashboard, which tracks goods supplied for a suggested due-date. Further enhancements may include a Revenue Dashboard, which tracks revenue for goods sold or services, a Planned Revenue versus Actual Revenue Dashboard, which helps monitor revenues collected against the operations plan and a Revenue Position versus Fiscal Plan Dashboard, which shows a granular approach towards revenue achieved by a user organization with respect to the user organization's fiscal plan.

In some embodiments, additional enhancements may include the generation of extension reports by the ERP application. Extension reports are a description of an enhancement employed in the supply chain optimization scheme, and may be targeted toward specific functions in the ERP application. Example extension reports may include, in accordance with some embodiments, a Supplier Projection Report which generates proposed supply details on demand, in order to ensure continuous operation, a Delayed Sales Order Report which generates delayed sales orders on demand, thereby helping business to expedite supply, and a Clear to Build Report which helps a planner identify sales orders that have not been cleared for build operations.

As will be appreciated by those ordinary skilled in the art, the foregoing example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code.

This description is presented to enable a person of ordinary skill in the art to make and use the disclosed embodiment and is provided in the context of the requirement for a obtaining a patent. The present description includes the best presently-contemplated method for carrying out the disclosed embodiment. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

What is claimed is:

1. A computer aided method for accelerating end-to-end supply chain optimization in a high technology organization, the method comprising:
identifying at least one existing system limitation associated with the high technology organization;
identifying a supply chain optimization scheme enabled by an enterprise resource planning implementation for the high technology organization on the basis of the one or more system limitations identified;
comparing one or more process flows and requirements associated with the supply chain of the high technology organization with a plurality of pre-developed process flows and requirements, wherein the pre-developed process flows and requirements are identified on the basis of best practices associated with the supply chain optimization scheme and contextualized to a high technology sector in which the high technology organization operates;
deploying a pre-developed enterprise resource planning system configuration kit for the enterprise resource planning implementation, wherein the configuration kit serves to configure the supply chain optimization scheme in accordance with the plurality of pre-developed process flows; and
providing a key performance indicator framework based on best practices and benchmarks relevant to the high technology organization, wherein the key performance indicator framework comprises one or more performance metrics by which the time and cost efficiency of a supply chain is measured, and one or more business issues faced by the high technology organization is derived thereby.

2. The method as claimed in claim 1, wherein the at least one system limitation is selected from the group consisting of demand volatility, inventory carrying cost and inventory optimization, logistics planning, on time delivery, forecast accuracy and strategic sourcing.

3. The method as claimed in claim 1, the method further comprising modifying the pre-developed enterprise resource planning system configuration kit on the basis of the comparison of the one or more requirements associated with the supply chain and the plurality of pre-developed process flows and requirements.

4. The method as claimed in claim 1, wherein the pre-developed enterprise resource planning system configuration kit comprises one or more configuration sheets that model one or more scenarios for supply chain optimization in a high technology sector in which the high technology organization operates.

5. The method as claimed in claim 1, wherein the previously identified process flows and requirements are encapsulated in one or more business requirement documents.

6. The method as claimed in claim 1, the method further comprising tailoring the supply chain optimization scheme in accordance with the one or more requirements associated with the supply chain managed by the high technology organization.

7. The method as claimed in claim 6, wherein the supply chain optimization scheme is tailored by means of one or more enhancements to the enterprise resource planning system, the one or more enhancements packaged and operable in the enterprise resource planning system deployed.

8. The method as claimed in claim 7, the method further comprising providing one or more extension reports generated by the enterprise resource planning system, wherein an extension report is a description of an enhancement employed in the supply chain optimization scheme.

9. The method as claimed in claim 1, wherein sales and operations planning activities of the high technology organization are optimized.

10. The method as claimed in claim 1, wherein demand sensing and shaping activities of the high technology organization are optimized.

11. The method as claimed in claim 1, wherein strategic sourcing activities of the high technology organization are optimized.

12. The method as claimed in claim 1, wherein production operations of the high technology organization are optimized.

13. The method as claimed in claim 1, wherein manufacturing activities of the high technology organization are optimized.

14. The method as claimed in claim 1, wherein warehouse management activities of the high technology organization are optimized.

15. The method as claimed in claim 1, wherein logistical activities of the high technology organization are optimized.

16. The method as claimed in claim 1, wherein activities related to retail execution are optimized.

17. A system for accelerating end to end supply chain optimization in a high technology organization, the system comprising:
a processor readable storage medium in communication with a processor, the processor readable storage medium containing one or more programming instructions configured to:
identify a supply chain optimization scheme enabled by an enterprise resource planning (ERP) implementation for a high technology organization, wherein the supply chain optimization is identified on the basis of the one or more system limitation in the supply chain of the high technology organization;
a comparison module adapted to compare one or more process flows and requirements associated with the supply chain of the high technology organization with a plurality of pre-developed process flows and requirements, wherein the pre-developed process flows and requirements are identified on the basis of best practices associated with the supply chain optimization scheme and contextualized to a high technology sector in which the high technology organization operates;
a deployment module adapted to deploy a pre-developed configuration kit for an ERP implementation, wherein the pre-developed configuration kit serves to configure the supply chain optimization scheme in accordance with the plurality of pre-developed process flows; and
provide a key performance indicator (KPI) framework based on best practices and benchmarks relevant to the high technology organization, wherein the key performance indicator framework comprises one or more performance metrics by which the time and cost efficiency of the supply chain is measured.

18. The system as claimed in claim 17, wherein the at least one system limitation is selected from the group consisting of demand volatility, inventory carrying cost and inventory optimization, logistics planning, on time delivery, forecast accuracy and strategic sourcing.

19. The system as claimed in claim 17, the system further comprising modifying the pre-developed enterprise resource planning system configuration kit on the basis of the comparison of the one or more requirements associated with the supply chain and the plurality of pre-developed process flows and requirements.

20. The system as claimed in claim 17, wherein the pre-developed enterprise resource planning system configuration kit comprises one or more configuration sheets that model one or more scenarios for supply chain optimization in a high technology sector in which the high technology organization operates.

21. The system as claimed in claim 17, wherein the previously identified process flows and requirements are encapsulated in one or more business requirement documents.

22. The system as claimed in claim 17, the system further comprising tailoring the supply chain optimization scheme in accordance with the one or more requirements associated with the supply chain managed by the high technology organization.

23. The system as claimed in claim 22, wherein the supply chain optimization scheme is tailored by means of one or more enhancements to the enterprise resource planning system, the one or more enhancements packaged and operable in the enterprise resource planning system deployed.

24. The system as claimed in claim 23, the system further comprising providing one or more extension reports generated by the enterprise resource planning system, wherein an extension report is a description of an enhancement employed in the supply chain optimization scheme.

25. The system as claimed in claim 17, wherein sales and operations planning activities of the high technology organization are optimized.

26. The system as claimed in claim 17, wherein demand sensing and shaping activities of the high technology organization are optimized.

27. The system as claimed in claim 17, wherein strategic sourcing activities of the high technology organization are optimized.

28. The system as claimed in claim 17, wherein production operations of the high technology organization are optimized.

29. The system as claimed in claim 17, wherein manufacturing activities of the high technology organization are optimized.

30. The system as claimed in claim 17, wherein warehouse management activities of the high technology organization are optimized.

31. The system as claimed in claim 17, wherein logistical activities of the high technology organization are optimized.

32. The system as claimed in claim 17, wherein activities related to retail execution are optimized.
